(19) United States
(12) Patent Application Publication
(10) Pub. No.: US 2006/0007224 A1
(43) Pub. Date: Jan. 12, 2006

(54) Image capturing function-equipped display device

(75) Inventors: Hirotaka Hayashi, Fukaya-shi (JP); Takashi Nakamura, Saitama-shi (JP); Miyuki Ishikawa, Kumagaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/121,962

(22) Filed: May 5, 2005

(30) Foreign Application Priority Data
May 31, 2004 (JP) P2004-162165
Feb. 8, 2005 (JP) P2005-32026

(51) Int. Cl. G09G 5/00

(52) U.S. Cl. 345/207

(57) ABSTRACT

In order to allow information input using light in both the cases of strong outside light and weak outside light, two or more types of light-sensing elements having different optical sensitivities are arranged in a picture element region. For example, there are alternately arranged rows having arranged therein picture elements 21 provided with low-sensitivity light-sensing elements, and rows having arranged therein picture elements 22 provided with high-sensitivity light-sensing elements. This constitution makes it possible to perform optical information input using the high-sensitivity light-sensing elements in the case of weak outside light, and to perform optical information input using the low-sensitivity light-sensing elements in the case of strong outside light.

### CROSS-REFERENCE TO RELATED APPLICATIONS

This application is based upon and claims the benefit of priority from Japanese Patent Applications No. 2004-162165 filed on May 31, 2004 and No. 2005-32026 filed on Feb. 8, 2005; the entire contents of which are incorporated herein by reference.

### BACKGROUND OF THE INVENTION

1. Field of the Invention

The present invention relates to an image capturing function-equipped display device which includes a light-sensing element for each picture element and in which information can be inputted from a screen by means of light.

2. Description of the Related Art

As a display device which includes a light-sensing element for each picture element and which is equipped with the function of capturing an image by detecting light inputted from a screen using each light-sensing element, for example, a technology described in Japanese Unexamined Patent Publication No. 2004-93894 has been known.

In a display device of this type, when a human finger comes close to the screen, light from the screen which is reflected by the finger is received by light-sensing elements, and currents according to the amount of light received are allowed to flow therethrough. By sensing these currents, a captured image is obtained in which a region on the screen where the finger is located can be recognized.

However, in a known display device, all light-sensing elements have a single sensitivity. Accordingly, there has been a problem that an image cannot be read in any one of the cases of weak outside light and strong outside light.

For example, in a case where high-sensitivity sensors are used, a display pattern on the screen is reflected by the finger to be inputted into the light sensors in weak outside light. Accordingly, the display pattern can be obtained as a captured image. On the other hand, in strong outside light, the outside light (multiple reflection of light at the interfaces of a glass substrate, a polarizing plate, and the like) enters a space between the finger and the screen. Thus, a whole captured image appears white because the sensors have high sensitivities.

### SUMMARY OF THE INVENTION

An object of the present invention is to provide an image capturing function-equipped display device in which information input can be realized by means of light in both the cases of strong outside light and weak outside light.

An image capturing function-equipped display device according to the present invention includes a picture element region including a plurality of picture elements; and a light-sensing element provided for each picture element. Here, two or more types of light-sensing elements having different optical sensitivities are arranged in the picture element region.

In the present invention, two or more types of light-sensing elements having different optical sensitivities are regularly arranged in the picture element region. By doing so, optical information can be inputted using higher-sensitivity light-sensing elements in the case of weak outside light, and optical information can be inputted using lower-sensitivity light-sensing elements in the case of strong outside light.

When the light-sensing elements are regularly arranged in the picture element region, the light-sensing elements are preferably arranged such that the sensitivities thereof differ between adjacent rows or columns. Further, the light-sensing elements may be arranged such that the sensitivities are varied in a checkerboard pattern.

Here, it is preferable that a plurality of light-sensing elements having different sensitivities are arranged in the picture element region to constitute a magic square. In this case, it is preferable that an average of values read from the plurality of light-sensing elements is regarded as a read intensity value of a picture element of interest which is contained in the magic square.

Further, it is preferable that the plurality of light-sensing elements having different sensitivities are arranged in the picture element region to constitute a magic square with alternate lines. The alternate lines are preferably any of alternate horizontal lines, alternate vertical lines, and alternate horizontal lines and alternate vertical lines.

### BRIEF DESCRIPTION OF THE DRAWINGS

FIG. 1 is a plan view showing an image capturing function-equipped display device of a first embodiment which is in a state where a plurality of types of light-sensing elements are arranged therein.

FIG. 2 is a schematic cross-sectional view of the image capturing function-equipped display device, which shows a light-sensing element receiving light.

FIG. 3 is a view showing an example of a display pattern on a screen.

FIG. 4A is an image captured by high-sensitivity light-sensing elements in weak outside light, and FIG. 4B is an image captured by low-sensitivity light-sensing elements in weak outside light.

FIG. 5A is an image captured by high-sensitivity light-sensing elements in strong outside light, and FIG. 5B is an image captured by low-sensitivity light-sensing elements in strong outside light.

FIG. 6 is a plan view showing a state where a plurality of types of light-sensing elements are arranged in a display device of a second embodiment.

FIG. 7 is a plan view showing a state where a plurality of types of light-sensing elements are arranged in a display device of a third embodiment.

FIG. 8 is a plan view showing a state where a plurality of types of light-sensing elements are arranged in a display device of a fourth embodiment.

FIG. 9 is a plan view showing a state where a plurality of types of light-sensing elements are arranged in a display device of a fifth embodiment.

FIG. 10 is a plan view showing a state where a plurality of types of light-sensing elements are arranged in a display device of a sixth embodiment.

FIG. 11 is a polarity distribution diagram showing a state where the drive polarities of picture elements differ between adjacent rows.

FIG. 12 is a plan view showing a state where a plurality of types of light-sensing elements are arranged in a display device of a seventh embodiment.

FIG. 13 is a view showing a group of four-by-four picture elements.

FIG. 14 is a plan view showing a range of eight-by-eight picture elements in which the pattern of the picture element group of FIG. 13 is repeatedly arranged.

FIG. 15 is a plan view showing another range of eight-by-eight picture elements in which the pattern of the picture element group of FIG. 13 is repeatedly arranged.

FIG. 16 is a view showing a range of 16-by-16 picture elements in which the pattern of the picture element group of FIG. 13 is repeatedly arranged.

### DESCRIPTION OF THE EMBODIMENTS

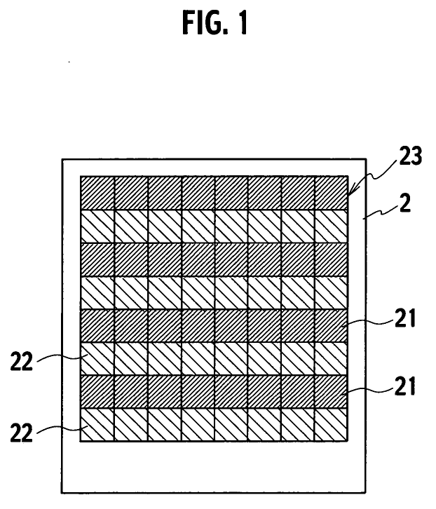

FIG. 1 is a plan view showing an image capturing function-equipped display device of a first embodiment which is in a state where a plurality of types of light-sensing elements are arranged therein. The display device of this drawing has a picture element region 23 provided with a plurality of picture elements 21 and 22, and light-sensing elements (not shown) provided for the respective picture elements; and has a constitution in which two or more types of light-sensing elements having different optical sensitivities are regularly arranged in the picture element region 23.

Each light-sensing element is, for example, a gate-controlled diode including a p region, an i region, and an n region. Each low-sensitivity light-sensing element has, for example, a constitution in which p+, p−, n−, and n+ regions are arranged in this order; each high-sensitivity light-sensing element has, for example, a constitution in which p+, p−, and n+ regions are arranged in this order. In this case, in the low-sensitivity light-sensing element, the p− and n− regions correspond to the i region; meanwhile, in the high-sensitivity light-sensing element, the p− region corresponds to the i region. Here, the p+region is a region containing a high concentration of p-type impurities, and the p− region is a region containing a low concentration of p-type impurities. Similarly, the n+region is a region containing a high concentration of n-type impurities, and the n− region is a region containing a low concentration of n-type impurities.

FIG. 1 shows a state where the light-sensing elements are arranged in the picture element region 23 such that the sensitivities differ between adjacent rows. Here, as an example, there are alternately arranged rows having arranged therein the picture elements 21 provided with the low-sensitivity light-sensing elements, and rows having arranged therein the picture elements 22 provided with the high-sensitivity light-sensing elements.

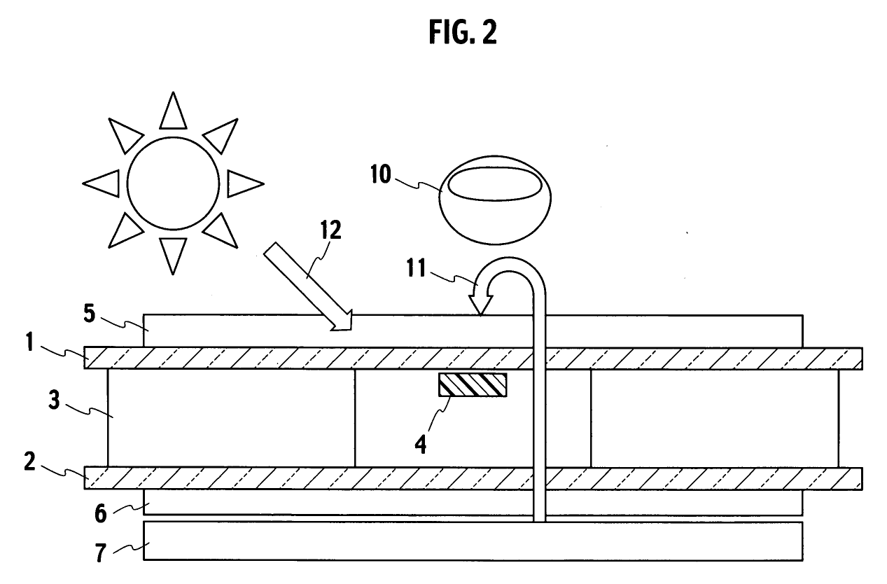

As shown in the cross-sectional view of FIG. 2, this image capturing function-equipped display device includes an array substrate 1 made of glass, a counter substrate 2 placed to face the array substrate 1, and a liquid crystal layer 3 therebetween. On the array substrate 1, a plurality of scan lines and a plurality of signal lines are wired so as to intersect each other. At each intersection, a picture element is located. Each picture element includes a picture element electrode for applying a voltage to the liquid crystal layer, a switching element which is turned on or off according to instructions indicated by a scan signal supplied to the scan line to apply a picture signal supplied to the signal line to the picture element electrode with appropriate timing, and the light-sensing element 4 which receives light from the outside and which converts the light into a current. A polarizing plate 5 is placed on the outer surface of the array substrate 1, and a polarizing plate 6 is placed on the outer surface of the counter substrate 2. A backlight 7 is placed on the outer surface of the polarizing plate 6.

Light 11 outputted by the backlight 7 is outputted to the outside of the display device through the polarizing plate 6, the counter substrate 2, the liquid crystal layer 3, the array substrate 1, and the polarizing plate 5. When a human finger 10 comes close to the outer surface of the polarizing plate 5, the light 11 is reflected by the finger 10. The light 11 reflected by the finger 10 is received by the light-sensing elements 4. Each light-sensing element 4 allows a current according to the amount of light received to flow therethrough. The image capturing function-equipped display device senses this current to obtain a captured image in which the region on the screen where the finger is located can be recognized.

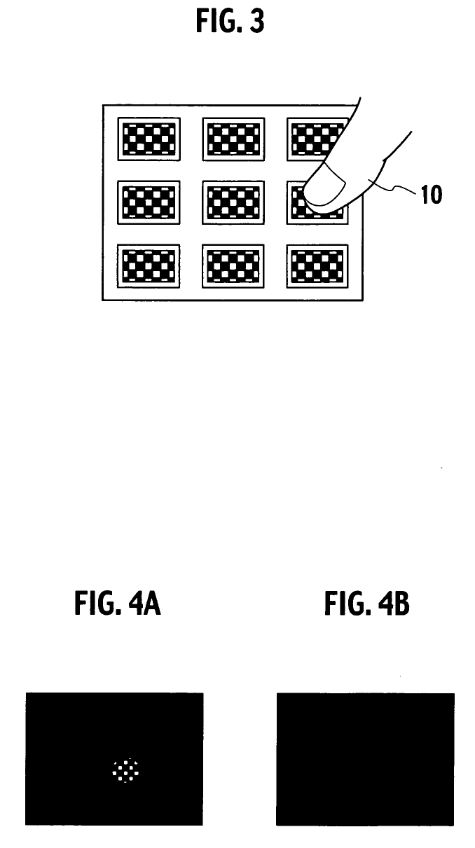

Next, the operation of the image capturing function-equipped display device will be described. As shown in FIG. 3, as an example, suppose that a checkerboard display pattern is displayed on the screen.

FIGS. 4A and 4B show images captured when the finger 10 has come close to the screen in weak outside light. In this case, the finger 10 reflects a checkerboard display pattern because the influence of the outside light is small. When extracting only an image captured by the higher-sensitivity light sensors, a checkerboard display pattern in the region to which the finger has come close is obtained as a captured image as shown in FIG. 4A, because the higher-sensitivity light-sensing elements can detect the reflected light. Meanwhile, when extracting only an image captured by the lower-sensitivity light sensors, a whole captured image appears black as shown in FIG. 4B because the lower-sensitivity light-sensing elements cannot detect light. In actual cases, since an image is obtained which is created by superimposing the captured images of FIGS. 4A and 4B, optical information can be inputted even in weak outside light.

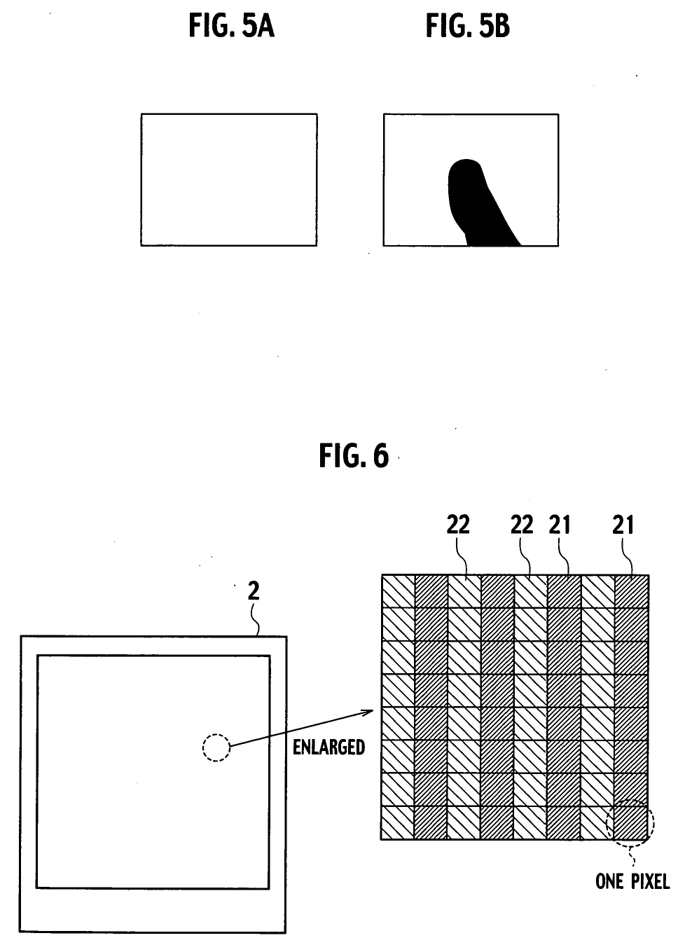

On the other hand, FIGS. 5A and 5B show images captured when the finger 10 has come close to the screen in strong outside light. In this case, the influence of the outside light is large. Accordingly, with the higher-sensitivity light-sensing elements, a whole captured image appears white as shown in FIG. 5A because the higher-sensitivity light-sensing elements allow too-large currents to flow therethrough according to the detected amount of light received. Meanwhile, with the light-sensing elements of the lower-sensitivity light-sensing elements on which the outside light is directly incident, a white captured image is obtained because the relevant light-sensing elements allow too-large currents to flow therethrough according to the amount of light received, though the relevant light-sensing elements are less sensitive; with the light-sensing elements of the lower-sensitivity light-sensing elements on which the outside light is not directly incident due to blockage by the finger 10, a captured image having a checkerboard pattern is not obtained because of the low sensitivities thereof, but a black captured image is obtained at least in the region where the finger is located. In actual cases, an image is obtained which is created by superimposing the captured images of FIGS. 5A and 5B. In the case of strong outside light, a captured image in which the region where the finger 10 is located can be recognized is obtained by performing appropriate image processing. A portion having a nearly checkerboard pattern may be detected in the image created by superimposing the captured images of FIGS. 5A and 5B. Alternatively, a portion having a nearly checkerboard pattern may be detected after the image created by superimposing the captured images of FIGS. 6A and 5B have been separated into the captured images of FIGS. 5A and 5B.

Thus, in this embodiment, two or more types of light-sensing elements having different optical sensitivities are regularly arranged in the picture element region. Accordingly, in a case where outside light is weak, a captured image can be obtained which is created by inputting optical information using the higher-sensitivity light-sensing elements. Meanwhile, in a case where outside light is strong, a captured image can be obtained which is created by inputting optical information using the lower-sensitivity light-sensing elements. Consequently, in both the cases of strong outside light and weak outside light, optical information input can be realized.

In this embodiment, the light-sensing elements are arranged in the picture element region such that the sensitivities differ between adjacent rows. However, the present invention is not limited to this. Various modifications will be described below.

As shown in the plan view of FIG. 6, an image capturing function-equipped display device of a second embodiment has a constitution in which the light-sensing elements are arranged in the picture element region such that the sensitivities differ between adjacent columns. This drawing shows, as an example, a state where there are alternately arranged columns having arranged therein the picture elements 21 provided with the low-sensitivity light-sensing elements, and columns having arranged therein the picture elements 22 provided with the high-sensitivity light-sensing elements. Also in a case where the light-sensing elements are thus arranged, effects similar to those of the first embodiment can be obtained.

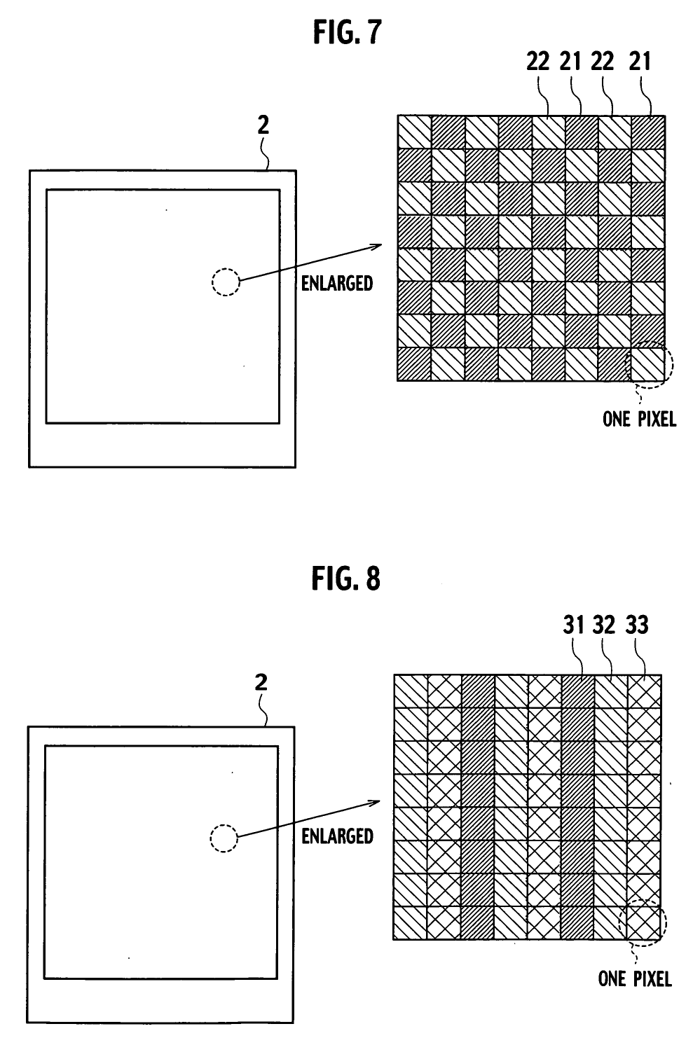

As shown in the plan view of FIG. 7, an image capturing function-equipped display device of a third embodiment has a constitution in which the light-sensing elements are arranged in the picture element region such that the sensitivities are varied in a checkerboard pattern. This drawing shows, as an example, a state where the picture elements 21 provided with the low-sensitivity light-sensing elements and the picture elements 22 provided with the high-sensitivity light-sensing elements are arranged in a checkerboard pattern. Also in a case where the light-sensing elements are thus arranged, effects similar to those of the first embodiment can be obtained.

As shown in the plan view of FIG. 8, an image capturing function-equipped display device of a fourth embodiment has a constitution in which three types of light-sensing elements having different sensitivities are regularly arranged. This drawing shows, as an example, a state where there are alternately arranged columns having arranged therein picture elements 31 provided with low-sensitivity light-sensing elements, columns having arranged therein picture elements 32 provided with intermediate-sensitivity light-sensing elements, and columns having arranged therein picture elements 33 provided with high-sensitivity light-sensing elements. Also in a case where the light-sensing elements are thus arranged, effects similar to those of the first embodiment can be obtained.

Incidentally, light-sensing elements having three or more types of different sensitivities may be arranged such that the sensitivities differ between adjacent rows or columns, or may be arranged in a checkerboard pattern.

Moreover, the sensitivity of the light-sensing element can be adjusted by changing the voltage on the gate electrode, if the light-sensing element is a gate-controlled diode. Further, the sensitivity of the light-sensing element can also be adjusted by changing at least one of the width and length of the light-sensing element.

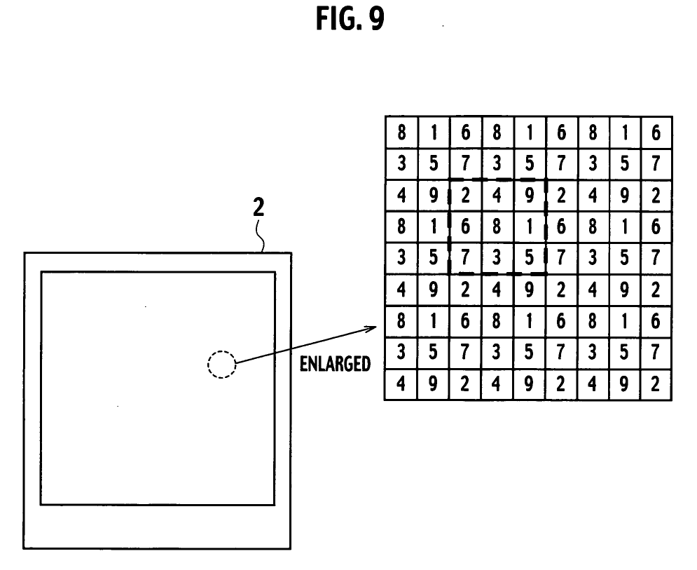

As shown in the plan view of FIG. 9, an image capturing function-equipped display device of a fifth embodiment has a constitution in which a plurality of light-sensing elements having different sensitivities are arranged in the picture element region so as to constitute magic squares. The phrase “to constitute magic squares” herein means repeatedly arranging a certain-number-by-certain-number picture element region in which light-sensing elements having different external appearances (size etc.) or sensitivities are irregularly arranged. This drawing shows, as an example, a state where a three-by-three picture element region in which nine types of light-sensing elements are regularly arranged is repeatedly arranged. Each number in this drawing indicates the sensitivity of the light-sensing element. The value of a photocurrent flowing through the sensor in constant light increases in proportion to the number.

In the case of the above-described arrangement, signals read by the sensors are processed in an external signal processing unit (not shown) as follows. First, an average of values (each 0 or 1) read from nine picture elements, including a picture element of interest and the surrounding ones, is regarded as the intensity value of the picture element of interest at the center of the three-by-three picture element region. This is performed on all picture elements. Thus, a new multi-level image is obtained. In the multi-level image thus obtained, it is unlikely that a portion indicated by a finger or the like is saturated and entirely becomes white or black in various ambient lights. This increases a probability that a read can be reliably performed. By performing predetermined image processing on this image, an accurate operation can be performed. For example, a coordinate detection operation or the like is performed based on this multi-level image.

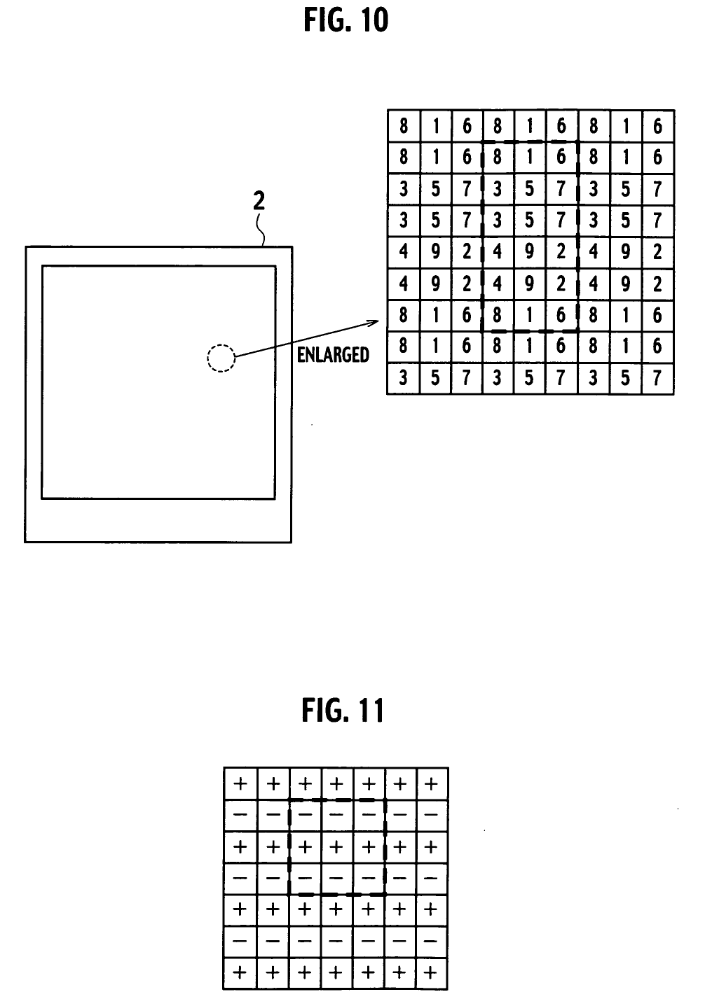

As shown in the plan view of FIG. 10, an image capturing function-equipped display device of a sixth embodiment has a constitution in which nine types of light-sensing elements having different sensitivities are arranged such that each group of the three-by-three picture elements with alternate horizontal lines constitutes a magic square. Each number in this drawing indicates the sensitivity of the light-sensing element. The value of a photocurrent flowing through the light-sensing element in constant light increases in proportion to the number. Arbitrary three-by-three picture elements constitute a magic square. In the case of such an arrangement, when alternate horizontal lines are driven, effects similar to those of the fifth embodiment can be obtained. Meanwhile, in a case where an arrangement is adopted in which each group of the three-by-three picture elements with alternate vertical lines constitutes a magic square, similar effects can be obtained when alternate vertical lines are driven.

Next, the arrangement of the light-sensing elements in which a consideration is given to the drive polarities of the picture elements will be described. Here, suppose that the horizontal lines of the picture elements having positive drive polarity and those of the picture elements having negative drive polarity are alternately arranged.

The polarity distribution diagram of FIG. 11 shows a state where the horizontal lines of positive polarity and those of negative polarity are alternately arranged. In this drawing, positive polarity is indicated by “+,” and negative polarity is indicated by “−.” With such drive polarities, in a case where nine types of the light-sensing elements having different sensitivities are arranged in a three-by-three picture element region as in the fifth embodiment, the number of the picture elements having positive polarity and that of the picture elements having negative polarity are different in this picture element region. Accordingly, an appropriate value cannot be obtained regarding an average of the intensity values thereof as the multi-level value of the picture element of interest at the center of the three-by-three picture element region.

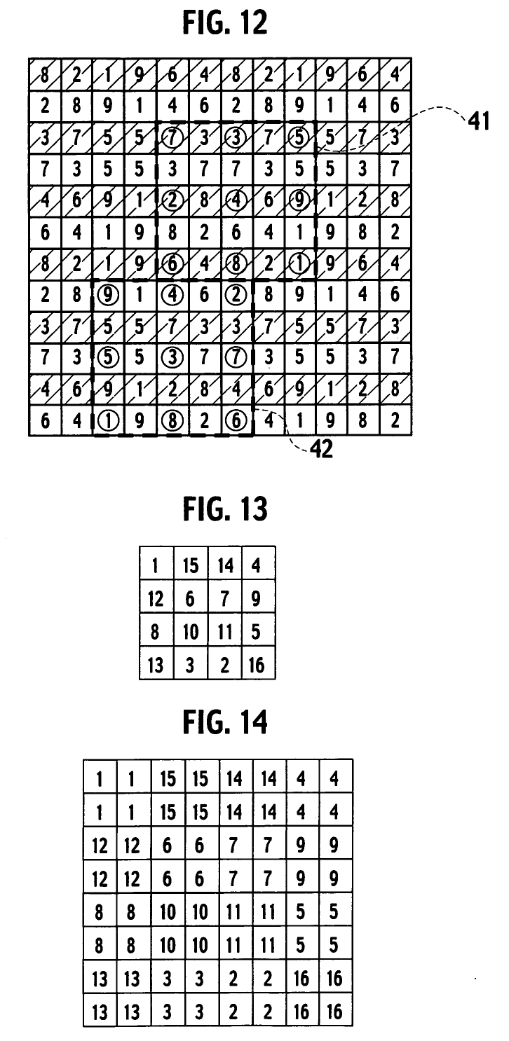

In light of this, in an image capturing function-equipped display device of a seventh embodiment, a plurality of light-sensing elements having different sensitivities are arranged such that a magic square is constituted with alternate horizontal lines and with alternate vertical lines. Here, as an example, as shown in the plan view of FIG. 12, nine types of the light-sensing elements are arranged such that each group of the three-by-three picture elements with alternate horizontal lines and with alternate vertical lines constitutes a magic square. In this drawing, diagonal lines indicate positive polarity, and the absence of diagonal lines indicates negative polarity.

As for the picture element region 41 in this drawing, the picture elements of which numbers are surrounded by circles in the drawing correspond to the three-by-three picture elements with alternate horizontal lines and with alternate vertical lines. The polarities of these picture elements are positive in common. Incidentally, each number in the drawing indicates the sensitivity of the light-sensing element. The fact that the value of a photocurrent flowing through the light-sensing element in constant light increases in proportion to the number is the same as in the aforementioned embodiments.

When finding the multi-level value of the picture element of interest at the center of the picture element region 41, an average is taken over the intensity values of the nine picture elements of which numbers are surrounded by circles. Since all the intensity values of these picture elements are positive polarity, a correct multi-level value can be obtained.

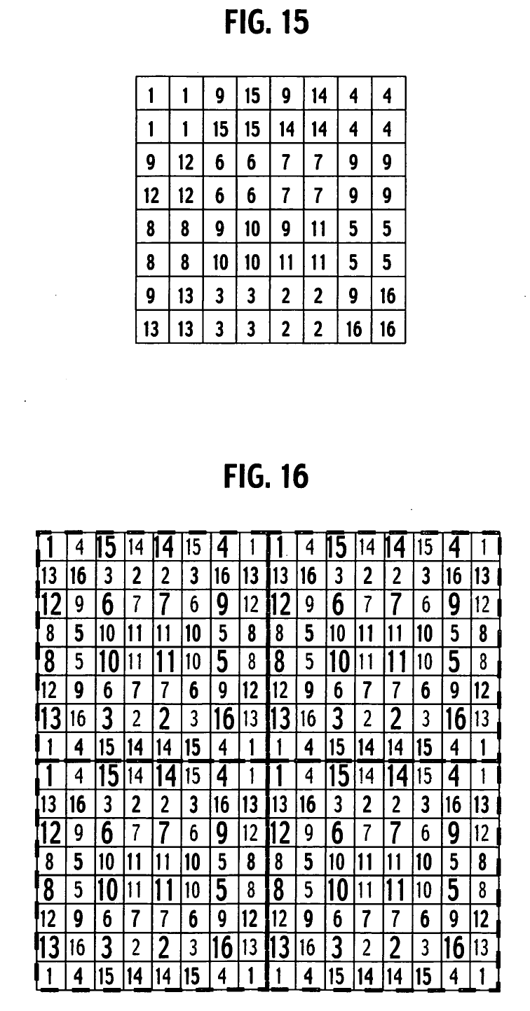

As for the picture element region 42 in the drawing, all the polarities of the three-by-three picture elements with alternate horizontal lines and with alternate vertical lines, which picture elements have numbers surrounded by circles, are negative. Accordingly, when finding the multi-level value of the picture element of interest at the center, a correct multi-level value can be obtained by taking an average over the intensity values of these picture elements. Although the case of the three-by-three picture elements has been described in this embodiment, four-by-four picture elements or eight-by-eight picture elements may be adopted. Considering the internal constitution (portion for calculating one intensity value using the values of the picture elements in a predetermined range) of an IC for the sensor, in a case where a magic square is constituted by the four-by-four picture elements and where the predetermined range corresponds to 16-by-16 picture elements, the memory of the IC can be efficiently configured. This is because, in many cases, the memory of the IC is arranged and configured such that eight bits constitute one character. FIG. 13 is an example of a four-by-four magic square. FIG. 14 is an example in which a four-by-four magic square is used in such a manner that alternate rows and alternate columns are skipped. The minimum (e.g., 4 um) of the width length of the sensor is determined on the basis of processing precision, and the maximum (e.g., 36 um) of the width lengths of the sensor is determined on the basis of restrictions on an aperture ratio. The difference between the minimum and the maximum is divided into equal lengths. FIG. 15 shows an example of a modification. The difference between the minimum of the width length of the sensor and the maximum thereof is divided into nine equal lengths. Portions corresponding to the width lengths longer than the maximum are assumed to have the maximum width length, and the lengths of the i layers of the pin sensors are varied. This makes it possible to increase the number of the sensors which have long width lengths and which can respond to light of low intensity. Further, since the lengths of the i layers are varied, any sensor has a value close to an optimum i-layer length and properly operates even if the optimum i-layer length changes due to somewhat process fluctuations. Thus, a process margin is widened. FIG. 16 shows an example in which blanks of FIG. 15 are filled. A magic square is reversed or the like so as to preferably avoid periodic display unevenness and capturing unevenness.

Thus, this embodiment makes it possible to exclude the influence of drive polarity and to obtain correct multi-level values in both of picture elements having positive polarity and those having negative polarity.

According to the above-described embodiments, since the plurality of light-sensing elements having different sensitivities are arranged, high-sensitivity sensors respond in a dark environment, and low-sensitivity sensors respond in a bright environment. Consequently, multi-level values having a wide dynamic range can be obtained. Further, since light-sensing elements having sensitivities appropriate to ambient light respond, image-capturing time can be shortened. Consequently, the number of captured-image frames per unit time can be increased.

A liquid crystal display device (LCD) for a mobile phone is often used in combination with a transparent acrylic plate as a protective plate. In this case, the finger does not directly touch a liquid crystal cell but touches the surface of the protective plate. Accordingly, the light sensors incorporated in the liquid crystal cell sense and respond to light due to multiple reflection of light (stray light) between the protective plate and the liquid crystal cell, between the glass-liquid crystal interface of the liquid crystal cell and the glass-polarizing plate interface thereof, between a backlight surface and the glass-polarizing plate interface, and the like, even if the light sensors lie under the finger. Consequently, in the case of a simple binary read in which “a white portion in the result of the read means outside light” and in which “a black portion means the finger,” white saturation occurs and the finger cannot be recognized in strong outside light due to white saturation. It is difficult to obtain a high S/N ratio because the finger itself does not have a light source. There occurs the problem that the shadow of the finger cannot be distinguished from the background (white saturation occurs) in a binary read in which a specific illumination is set as a threshold and in which a read process is performed by regarding values above the threshold as white and regarding values below the threshold as black (this problem is the same in all the aforementioned embodiments to greater or lesser degrees because of the thickness of the glass substrate even though the protective plate does not exist).

Accordingly, a constitution for reading the difference between the intensity of the finger and that of the background is needed. It is possible to conceive of performing area coverage modulation on raw data (binary) read. Further, an anti-white saturation measure is taken by increasing the number of the levels of the sensors. Here, the area coverage modulation means calculating an average value of binary outputs of the plurality of sensors in the vicinity of a picture element of interest and regarding the average as a new intensity value. The size of the vicinity can be optimized based on the size of an indicating substance such as a finger, the pitch of the sensors, and the like. The phrase “increasing the number of the levels of the sensors” means the following: insensitive sensors having a plurality of levels are intentionally mixed in addition to relatively sensitive sensors which are effective in dark places, and the sensors are made to function in a wider illumination range, thus preventing white saturation. Also from such a viewpoint, the aforementioned embodiments are effective. Further, picture elements containing the sensors having the plurality of levels have slightly different shapes. If these picture elements are regularly arranged, periodic display unevenness is prone to be observed when normal display is performed. Further, there are cases where periodic unevenness occurs in a captured image. Accordingly, the plurality of picture elements having the plurality of sensors are preferably irregularly arranged. The aforementioned magic square arrangements are the examples thereof. In the aforementioned examples, descriptions have been made by setting the levels of the sensors as 1:2: . . . :9. However, precisely equal differences are not needed. Moreover, equal ratios may be adopted. The number of the levels has been nine, but is not limited to it. It is essential that the number of the sensors which respond to the illumination of outside light increases. If there are portions in which the number of the sensors responding to the illumination of outside light does not increase, that is a problem. This is because the difference between the intensity of outside light and that of a finger cannot be read in the relevant region.

A similar thing can also be performed by reading as multi-level signals the outputs of the sensors on the glass substrate from the first use of multi-level AID converter. However, the constitution (binary sensor signals are outputted from the glass substrate and subjected to area coverage modulation on the outside to be converted into multi-level data) of the present invention is more advantageous in terms of cost and ease of design (non-severe noise design).

The method of changing the sensitivity of the sensor is variously devised besides the size of the sensor is changed. For instance, it is possible to change the exposure time of each line and to take picture. It is preferable to combine changing the size of the sensor and changing the exposure time.

What is claimed is:

1. An image capturing function-equipped display device, comprising:
a picture element region including a plurality of picture elements; and
a light-sensing element provided for each picture element,
wherein two or more types of the light-sensing elements having different optical sensitivities are arranged in the picture element region.

2. The display device according to claim 1,
wherein the light-sensing elements are arranged in the picture element region such that the sensitivities thereof differ between adjacent rows.

3. The display device according to claim 1,
wherein the light-sensing elements are arranged in the picture element region such that the sensitivities thereof differ between adjacent columns.

4. The display device according to claim 1,
wherein the light-sensing elements are arranged in the picture element region such that the sensitivities thereof are varied in a checkerboard pattern.

5. The display device according to claim 1,
wherein the plurality of light-sensing elements having different sensitivities are arranged in the picture element region to constitute a magic square.

6. The display device according to claim 5,
wherein the values read from the plurality of light-sensing elements are used for a read intensity value of a picture element of interest which is contained in the magic square.

7. The display device according to claim 1,
wherein the plurality of light-sensing elements having different sensitivities are arranged in the picture element region to constitute a magic square by excluding the one with different polarity of the display.

8. The display device according to claim 7,
wherein the alternate lines are any of alternate horizontal lines, alternate vertical lines, and alternate horizontal lines and alternate vertical lines.

9. An image capturing function-equipped display device,
wherein a plurality of picture elements having a plurality of types of sensors are irregularly arranged to constitute a picture element group, the plurality of types of the sensors responding to different illuminations, and the picture element group is repeatedly arranged in a display region.

10. An image capturing function-equipped display device,
wherein a picture element range for a calculation for area coverage modulation is determined so that an arrangement efficiency of the inside of an IC becomes advantageous, and a group of picture elements belonging to positive-polarity picture elements and a group of picture elements belonging to negative-polarity picture elements are equally contained in the range.

11. The display device according to claim 10,
wherein the picture element range is a range of 16-by-16 picture elements, and the groups of the picture elements are constituted in units of four-by-four picture elements.
